(19) United States
(12) Patent Application Publication
(10) Pub. No.: US 2016/0044581 A1
(43) Pub. Date: Feb. 11, 2016

(54) APPARATUS AND METHOD OF OPTIMIZED SERVICE ACQUISITION SCAN IN WIRELESS COMMUNICATIONS

(71) Applicant: QUALCOMM Incorporated, San Diego, CA (US)

(72) Inventor: Ameya Rajendraprasad Kasbekar, San Diego, CA (US)

(21) Appl. No.: 14/453,449

(22) Filed: Aug. 6, 2014

(51) Int. Cl. H04W 48/16

(52) U.S. Cl. CPC H04W 48/16

(57) ABSTRACT

One or more aspects of the disclosure provide for an improved service scan operable at an access terminal (AT). At power up or selection/reselection, the AT maintains a record of the best and worst possible rank of the system records associated with each acquisition record that is read. When performing a service scan, the AT sorts the acquisition records by the best possible rank in ascending order. For further optimization, according to some aspects of the disclosure, all acquisition records of the same best possible rank may be sorted in ascending order of the least possible rank.

### TECHNICAL FIELD

Aspects of the present disclosure relate generally to wireless communications, and more specifically, to service scan using a preferred roaming list.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power).

A Preferred Roaming List (PRL) is a database or record residing in an access terminal (AT) that contains information used during a system selection and acquisition process. For example, in the case of code-division multiple access (CDMA) devices, the PRL typically resides on a removable user identity module (R-UIM). The PRL generally provides to the AT information about the bands, channels, and service providers, and their respective priorities, for use when the AT is acquiring service after power-on or when a system reselection is needed.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One or more aspects of the disclosure provide for an improved service scan operable at an access terminal (AT). At power up or selection/reselection, the AT maintains a record of the best and worst possible rank of the system records associated with each acquisition record that is read. When performing a service scan, the AT sorts the acquisition records by the best possible rank in ascending order. For further optimization, according to some aspects of the disclosure, all acquisition records of the same best possible rank may be sorted in ascending order of the least possible rank.

One aspect of the disclosure provides a method of service scan operable at an access terminal (AT). The AT parses a preferred roaming list (PRL) including a plurality of acquisition records and a plurality of system records. For each of the acquisition records, the AT ranks the system records associated with the acquisition record. In addition, the AT performs a service scan utilizing the acquisition records in an order based on the ranking of the system records associated with each of the acquisition records.

Another aspect of the disclosure provides an access terminal (AT) for wireless communications. The AT includes means for parsing a preferred roaming list (PRL) that includes a plurality of acquisition records and a plurality of system records. The AT further includes means for ranking the system records associated with each of the acquisition records. The AT further includes means for performing a service scan utilizing the acquisition records in an order based on the ranking of the system records associated with each of the acquisition records.

Another aspect of the disclosure provides a computer-readable medium that includes code for causing an access terminal (AT) to various tasks. The code causes the AT to parse a preferred roaming list (PRL) that includes a plurality of acquisition records and a plurality of system records. The code further causes the AT to for each of the acquisition records, rank the system records associated with the acquisition record. The code further causes the AT to perform a service scan utilizing the acquisition records in an order based on the ranking of the system records associated with each of the acquisition records.

Another aspect of the disclosure provides an access terminal (AT) for wireless communications. The AT includes at least one processor, a communication interface coupled to the at least one processor, a memory coupled to the at least one processor. The AT further includes a preferred roaming list parsing component configured to parse a preferred roaming list (PRL) that includes a plurality of acquisition records and a plurality of system records. The AT further includes a system ranking component configured to rank the system records associated with each of the acquisition records. The AT further includes a service scan component configured to perform a service scan utilizing the acquisition records in an order based on the ranking of the system records associated with each of the acquisition records.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal.

FIG. 3 is a schematic diagram illustrating an access terminal configured to perform an optimized service acquisition scan in accordance with an aspect of the present disclosure.

FIG. 4 is a block illustrating an example of a hardware implementation for an apparatus employing a processing system in accordance with an aspect of the disclosure.

FIG. 5 is a flow chart illustrating a method of performing an optimized service scan based on the ranking of system records associated with acquisition records in accordance with an aspect of the disclosure.

FIG. 6 is a drawing illustrating a preferred roaming list including a number of acquisition records and system records according to one example.

FIG. 7 is a flow chart illustrating a method of determining the most preferred rank (MPR) and least preferred rank (LPR) of an acquisition record in accordance with an aspect of the disclosure.

FIG. 8 is a flow chart illustrating a method of selecting acquisition records for service scan in accordance with an aspect of the disclosure.

FIG. 9 is a flow chart illustrating a method of selecting acquisition records with the same MPR for service scan in accordance with an aspect of the disclosure.

FIG. 10 is a drawing illustrating acquisition records and system records of a preferred roaming list according to another example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of wireless communication systems, network architectures, and communication standards. Certain aspects of the discussions are described below for CDMA and 3rd Generation Partnership Project 2 (3GPP2) 1× protocols and systems, and related terminology may be found in much of the following description. However, those of ordinary skill in the art will recognize that one or more aspects of the present disclosure may be employed and included in one or more other wireless communication protocols and systems.

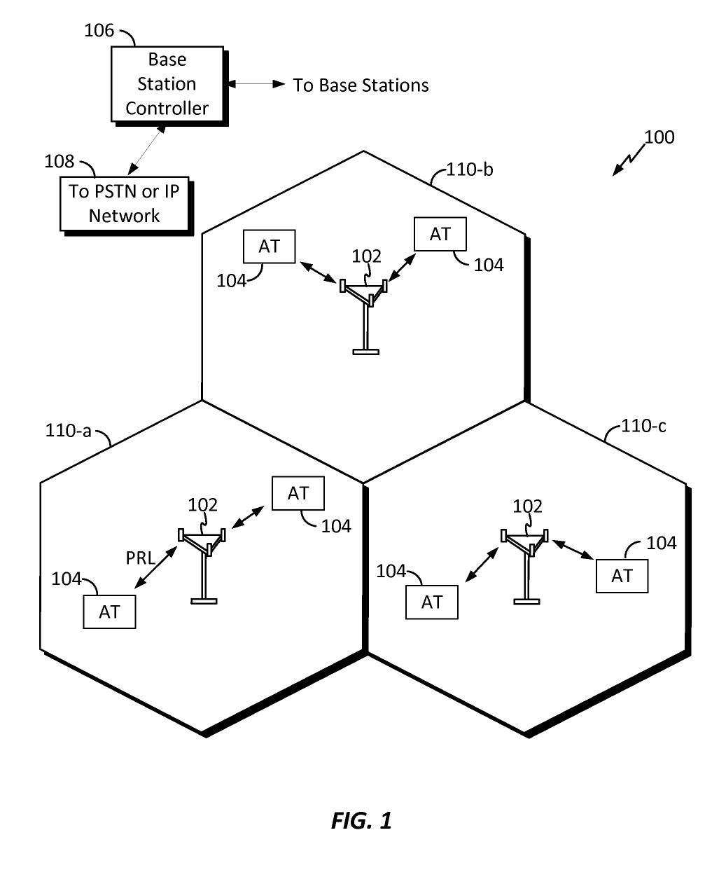

FIG. 1 is a block diagram illustrating an example of a network environment in which one or more aspects of the present disclosure may find application. The wireless communication system 100 generally includes one or more base stations 102, one or more access terminals (ATs) 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 102 can wirelessly communicate with the ATs 104 via one or more base station antennas. The base stations 102 may each be implemented generally as a device adapted to facilitate wireless connectivity (for one or more ATs 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, eNode B, a femto cell, a pico cell, and/or some other suitable terminology.

The base stations 102 are configured to communicate with the ATs 104 under the control of the base station controller 106 via multiple carriers. Each of the base stations 102 can provide communication coverage for a respective geographic area. The coverage area 110 for each base station 102 here is identified as cells 110-a, 110-b, or 110-c, for example. The coverage area 110 for a base station 102 may be divided into sectors (not shown). In a coverage area 110 (e.g., 110-a, 110-b, or 110-c) that is divided into sectors, the multiple sectors within the coverage area can be formed by groups of antennas with each antenna responsible for communication with one or more As 104 in a portion of the cell.

One or more ATs 104 may be dispersed throughout the coverage areas 110, and may wirelessly communicate with one or more sectors associated with each respective base station 102. An AT 104 may generally include one or more devices that communicate with one or more other devices through wireless signals. Such ATs 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. The ATs 104 may include mobile terminals and/or at least substantially fixed terminals. Some non-limiting examples of ATs 104 include mobile phones, smartphones, pagers, wireless modems, personal digital assistants, personal information managers (PIMs), personal media players, palmtop computers, laptop computers, tablet computers, televisions, appliances, e-readers, digital video recorders (DVRs), machine-to-machine devices, automotive computers, and/or other communication/computing devices which communicate, at least partially, through a wireless or cellular network.

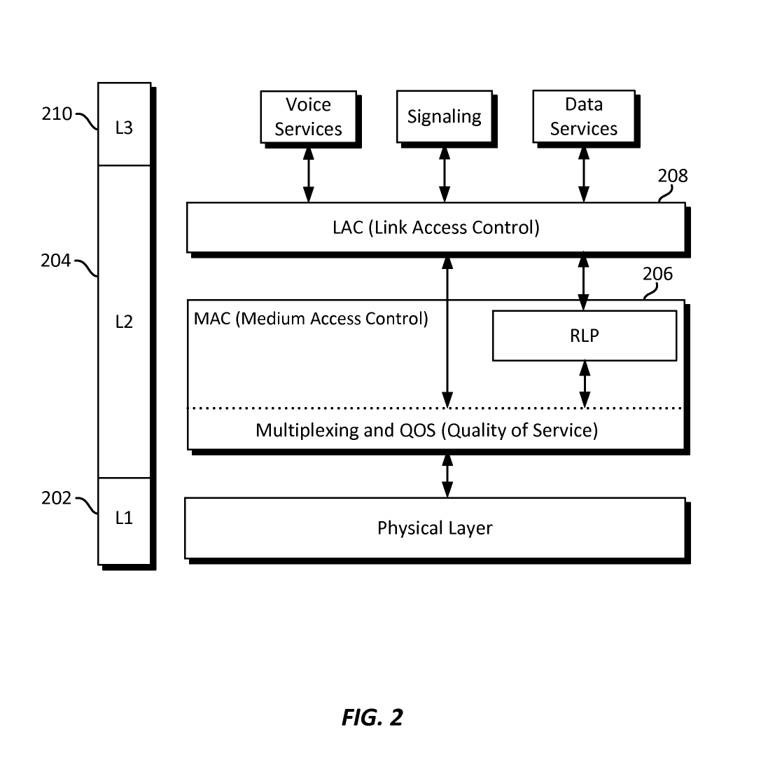

The AT 104 may be adapted to employ a protocol stack architecture for communicating data between the AT 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an AT 104. Referring to FIGS. 1 and 2, the protocol stack architecture for the AT 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between the AT 104 and a base station 102.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the AT 104. The L3 layer 210 makes use of the services provided by the L2 layer. Information (both data and voice) message are also passed through the L3 layer 210.

After power up, during system selection/reselection, or loss of service, an AT 104 performs a service scan to acquire service based on a database, for example, a Preferred Roaming List (PRL), which is typically provided by the network and stored at the AT 104. In one example, during the service scan, the AT 104 scans for potential system frequencies from which the AT 104 can acquire service. For each potential frequency, the AT 104 attempts to acquire the pilot channel, synchronization channel and/or other signaling channels (e.g., paging channels and control channels). Subsequently, the AT 104 can obtain system configuration information such that the AT 104 can receive services from the network.

The PRL generally provides to the AT 104 information about the frequency bands, channels, and service providers, and their respective priorities, for use when the AT 104 is acquiring service. One example of the PRL is defined in the document 3GPP2 C.S0016-B (version 1.0), which is incorporated herein by reference. The AT 104 can acquire a suitable system (e.g., a preferred system) to receive service using the information from the PRL. In one example, the PRL consists of a number of acquisition records (indexed in an acquisition table) and system records (indexed in a system table). There may be a many-to-many mapping between these two types of records. That is each acquisition record can correspond to many system records, and each system record can correspond to many acquisition records.

The AT 104 (e.g., a modem of the AT) initiates a service scan using an acquisition record, and compares the response from the network to the corresponding system records. The system records are grouped and ranked according to their respective geographical region (GEO). In the conventional art, however, the acquisition records do not contain this information regarding the system records. During the power up, reselection, and/or service loss scan, when the most recently used (MRU) and last GEO have been scanned, the rest of the PRL acquisition records are not scanned in any particular order. Rather, they are typically scanned in the order they were read from the PRL. Therefore, it is possible that an acquisition record for a less preferred system from GEO1 is scanned before the acquisition record for the more preferred system from GEO2.

In conventional implementations, the two record types (i.e., acquisition records and system records) are utilized independent of one another when running a service scan. Because the two types of records are handled separately, an additional round of scan may be performed when a less preferred system is acquired, to ensure that all more preferred systems within the GEO are evaluated. This will undesirably consume additional power and time.

According to aspects of the disclosure, an AT maintains in every acquisition record information regarding the ranks of the associated system records. For example, the highest rank is rank number 1, and increasing rank numbers indicate increasingly lower ranks. A system record with a higher rank is more preferred than a system record with a lower rank. At power up or selection/reselection, when parsing a PRL, the AT maintains a record of the best and worst possible rank of the system records associated with each acquisition record that is read. In one example, each acquisition record at the AT may include information on its best possible rank (most preferred rank) and its least possible rank (least preferred rank), with reference to the associated system records. Thus, when performing a service scan, the acquisition records could be sorted by the best possible rank in each GEO in ascending order, so as to ensure that all the acquisition records for the more preferred systems in each GEO are scanned first. For further optimization, according to some aspects of the disclosure, all acquisition records of the same best possible rank may be sorted in ascending order of the least possible rank.

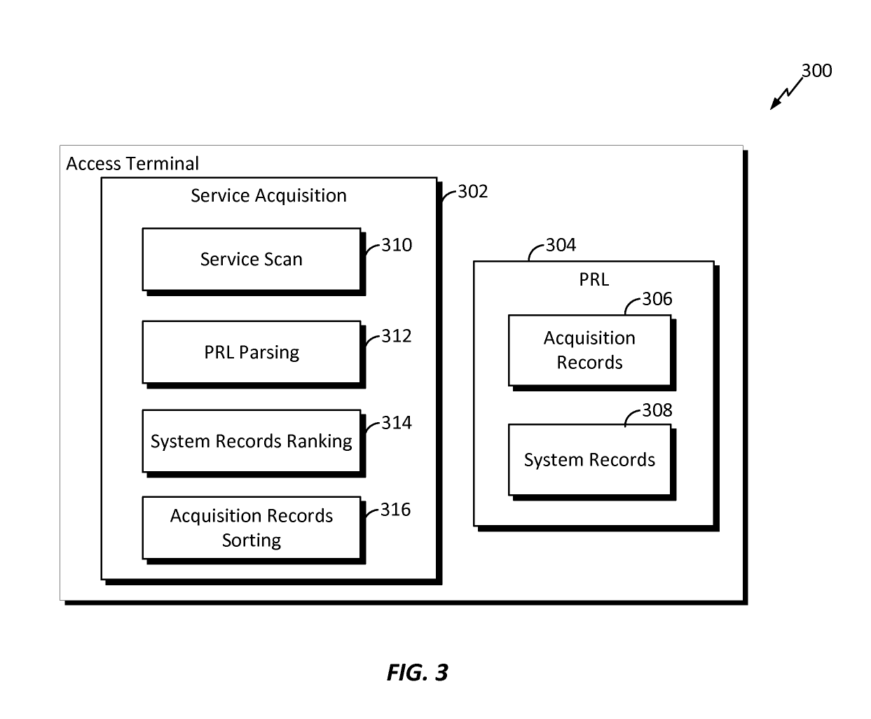

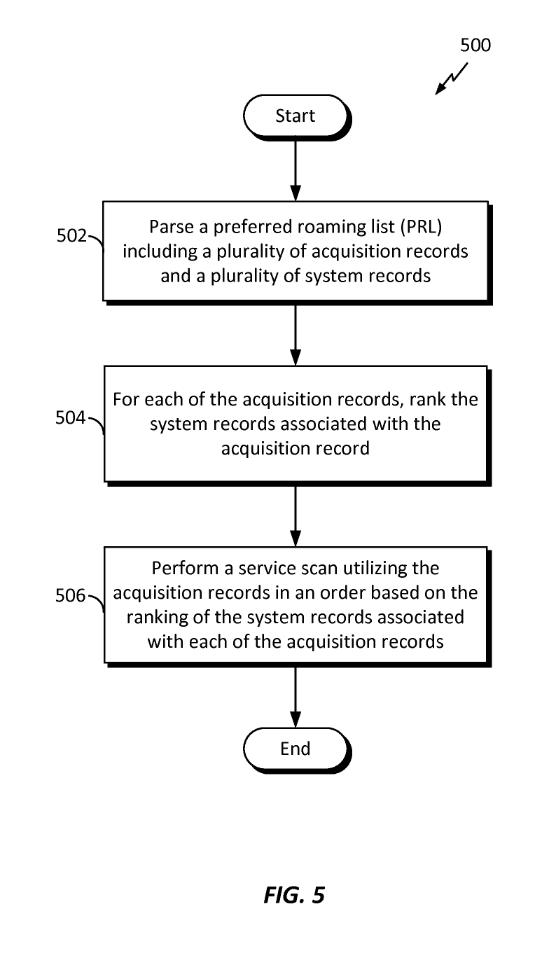

FIG. 3 is a schematic diagram conceptually illustrating an AT 300 configured to perform an optimized service scan in accordance with an aspect of the present disclosure. The AT 300 may be an AT as illustrated in any one or more of FIGS. 1 and/or 4. The AT 300 includes a number of blocks or components that may be implemented in software, hardware, firmware, or a combination thereof The AT 300 may be used to perform any of the methods illustrated in FIGS. 5, 7, 8, and/or 9. The AT 300 includes a service acquisition block 302 that may be utilized to perform a service scan based on a PRL 304. The PRL 304 may be received from the network and stored at the AT 300. The PRL 304 provides an acquisition table 306 and a system table 308. The acquisition table 306 has a number of acquisition records, and the system table 308 has a number of system records.

The service acquisition block 302 includes a service scan component 310, a PRL parsing component 312, a system records ranking component 314, and an acquisition records sorting component 316. The PRL parsing component 312 may be used to parse the PRL 304 such that the information contained in the acquisition records and system records may be analyzed and used in other processes. For example, parsing the PRL 304 may include looking up and comparing information in each of the acquisition records 306 and system records 308, such that the association between each acquisition record and one or more system records may be determined The system records ranking component 314 may be used to rank the system records 308 associated with each of the acquisition records 306. For example, system records 308 may be ranked from the most preferred rank (e.g., rank 1 being the most preferred) to the least preferred rank. The acquisition records sorting component 316 may be used to sort the acquisition records 306 based on the ranking of the system records 308. The service scan component 310 may be used to perform a service scan or acquisition scan utilizing the sorted acquisition records 306. More detail of the components of the AT 300 will be described below using some illustrative examples.

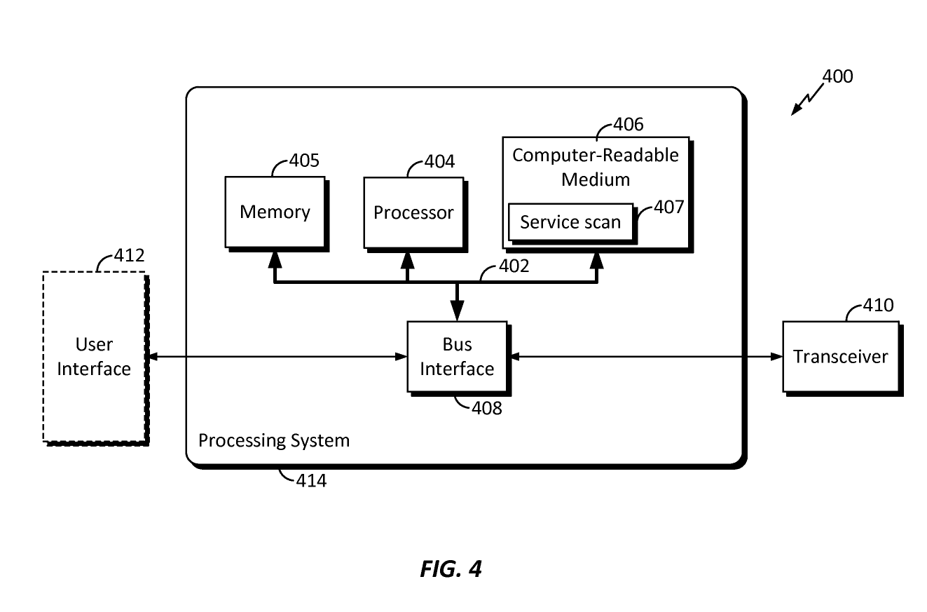

FIG. 4 is a conceptual diagram illustrating an example of a hardware implementation for an apparatus 400 employing a processing system 414. In accordance with various aspects of the disclosure, an element, or any portion of an element, or any combination of elements may be implemented with a processing system 414 that includes one or more processors 404. For example, the apparatus 400 may be an AT as illustrated in any one or more of FIGS. 1 and/or 3. An AT may include all or some of the blocks or components illustrated in FIGS. 3 and 4. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 404, as utilized in an apparatus 400, may be used to implement any one or more of the processes described below and illustrated in FIGS. 5 and 7-9.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick, touchscreen, touchpad) may also be provided.

The processor 404 is responsible for managing the bus 402 and general processing, including the execution of software stored on the computer-readable medium 406. The software, for example a service scan software 407, when executed by the processor 404, causes the processing system 414 to perform the various functions described in FIGS. 5 and 7-9 for any particular apparatus. The computer-readable medium 406 may also be used for storing data (e.g., a PRL 304 and ranking information of the records) that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

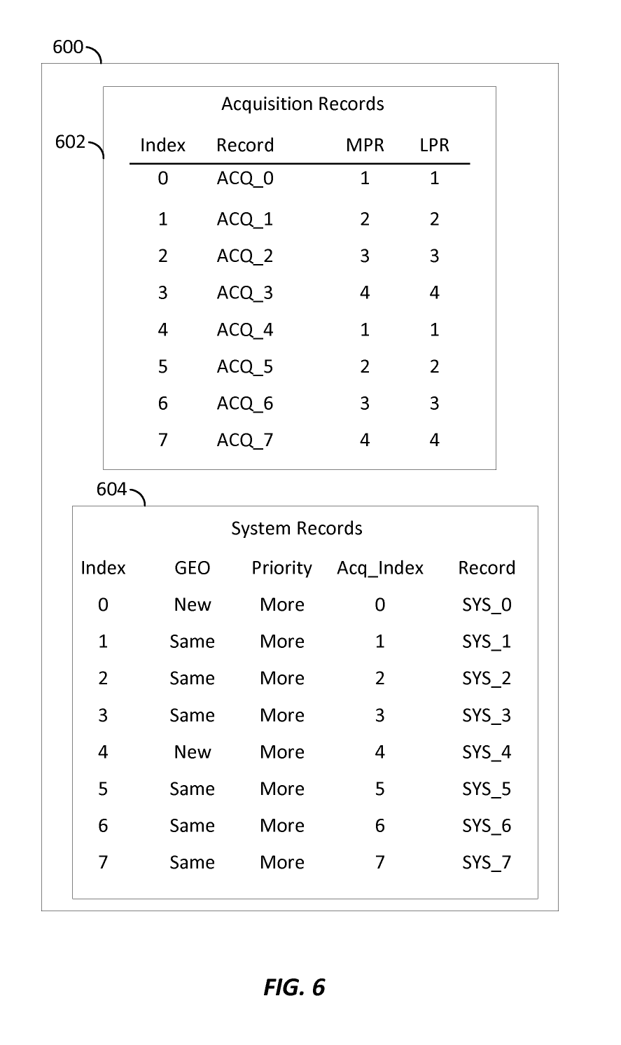

FIG. 5 is a flow chart illustrating a method 500 of performing an optimized service scan based on the ranking of system records associated with acquisition records in accordance with an aspect of the disclosure. FIG. 6 is a drawing illustrating a PRL 600 including acquisition records and system records according to one example. The method 500 may be performed by any AT illustrated in FIGS. 1, 3, and/or 4, or any suitable AT. At block 502, to perform an optimized service scan, an AT parses a PRL 600 that includes a number of acquisition records 602 and system records 604. In one example, the AT may use the PRL parsing component 312 to parse the PRL 600 such that the information contained in the acquisition records 602 and system records 604 may be used during the service scan.

At block 504, for each one of the acquisition records 602, the AT ranks the system records 604 associated with that acquisition record. The most preferred rank will be rank 1, with the rank increasing numerically for every level of less preferred rank within that GEO. For example, an AT may utilize a system records ranking component 314 to rank the system records 604. Referring to FIG. 6, the AT determines a most preferred rank (MPR) and a least preferred rank (LPR) of the system records associated with each acquisition record. The MPR and LPR information may be maintained as part of the acquisition record or a separate record. For example, the MPR and LPR are both 1 for the acquisition record ACQ_0 in the PRL 600. Similarly, the MPR and LPR are both 2 for the acquisition record ACQ_1. In some examples, the MPR and LPR of an acquisition record may not be the same.

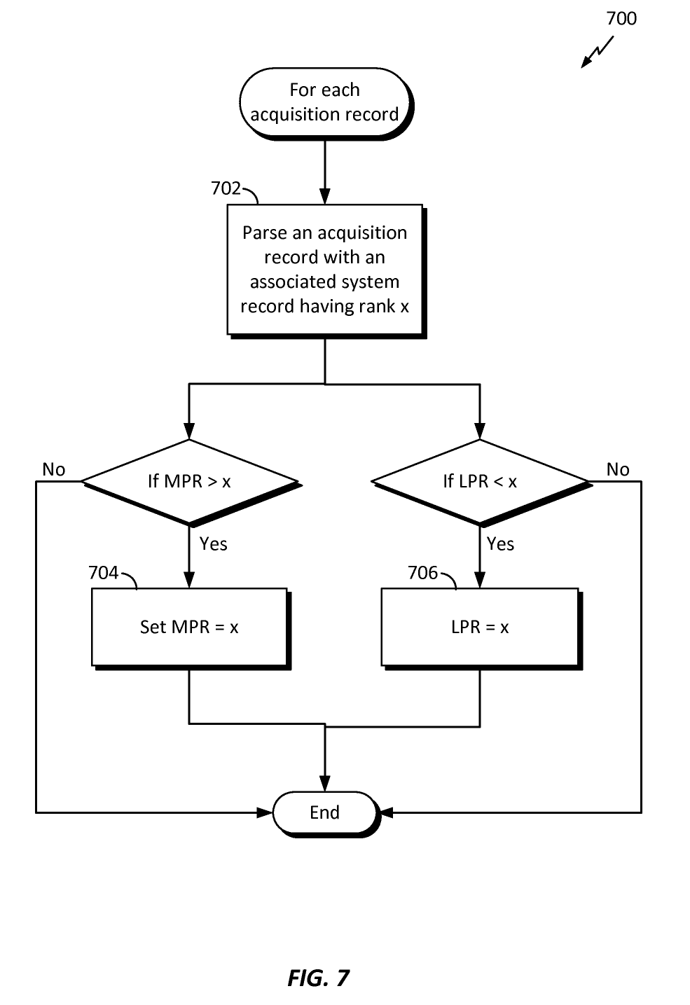

FIG. 7 is a flow chart illustrating a method 700 of determining the MPR and LPR of an acquisition record in accordance with an aspect of the disclosure. For example, the method 700 may be performed at block 504 of FIG. 5 by an AT 300 of FIG. 3. At block 702, an AT parses an acquisition record with an associated system record having rank x within a GEO. For example, the acquisition record may be any of the acquisition records 602 of FIG. 6. If the current MPR of the acquisition record is greater than x (i.e., less preferred than x), the AT sets the MPR to rank x at block 704. Also, if the current LPR of the acquisition record is less than x (i.e., more preferred than x), the AT sets the LPR to rank x at block 706. The method 700 is repeated for each acquisition record in the PRL.

At block 506, referring back to FIG. 5, the AT performs a service scan utilizing the acquisition records in an order based on the ranking of the associated system records. That is, the AT chooses the next acquisition record during service scan based on the ranking of the associated system records. In one example, the AT may utilize a service scan component 310 (see FIG. 3) to perform the service scan of block 506. In one aspect of the disclosure, when performing the service scan, the AT sorts the acquisition records in an ascending order of the MPR. For example, the AT may utilize an acquisition records sorting component 316 (see FIG. 3) to perform the sorting. In one aspect of the disclosure, for acquisition records with the same MPR, the AT may sort them in an ascending order of the LPR. In the PRL 600 of FIG. 6, for example, the AT will select the acquisition records in the order of ACQ_0, ACQ_4, ACQ_1, ACQ_5, ACQ_2, ACQ_6, ACQ_3, and ACQ_7. In the conventional art, however, an AT would scan the acquisition records in the order as they appear in the PRL 600. That is, the AT would perform scanning in the order of ACQ_0, ACQ_1, ACQ_2, ACQ_3, ACQ_4, ACQ_5, ACQ_6, and ACQ_7.

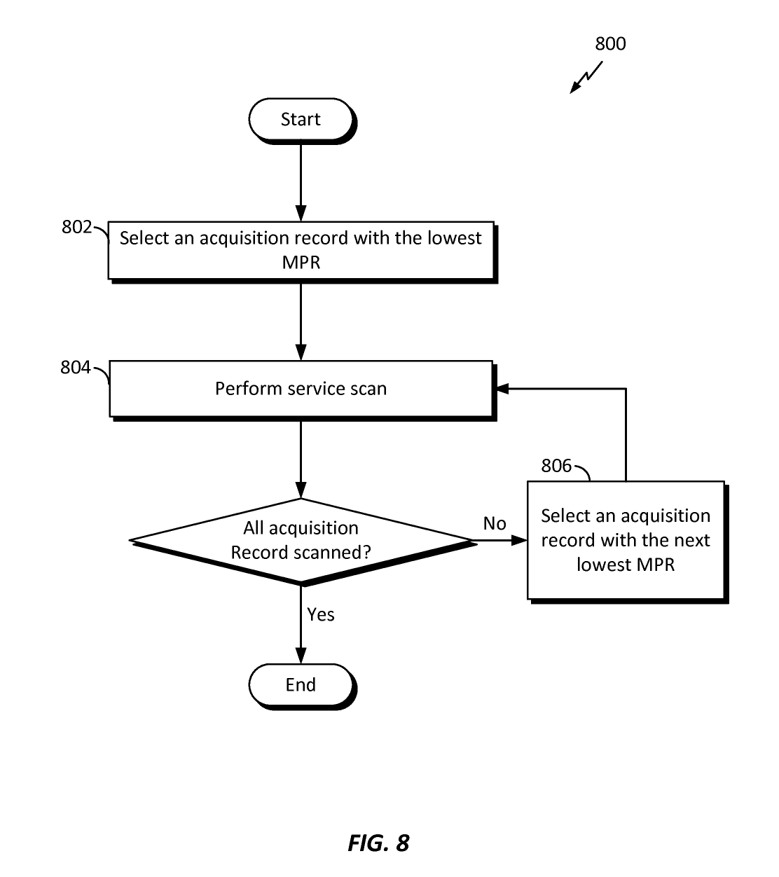

FIG. 8 is a flow chart illustrating a method 800 of selecting acquisition records for a service scan in accordance with an aspect of the disclosure. The method 800 may be performed by an AT as illustrated in any of FIGS. 1, 3, and/or 4. In one example, the method 800 may be performed in block 506 of FIG. 5 by an AT 300. At block 802, the AT selects an acquisition record with the lowest MPR to start the service scan. For example, the acquisition record may be the record ACQ_0 of the acquisition records 602 of FIG. 6. At block 804, the AT performs the service scan with the selected acquisition record. If there are more acquisition records to be scanned, the AT selects an acquisition record with the next lowest MPR in block 806 and performs service scan again in block 804. For example, the AT may select the record ACQ_4 for the next scan. The AT repeats this process until all the acquisition records are scanned. In an aspect of the disclosure, for acquisition records with the same MPR, the AT may scan these records in a predetermined order such as an ascending order of the LPR.

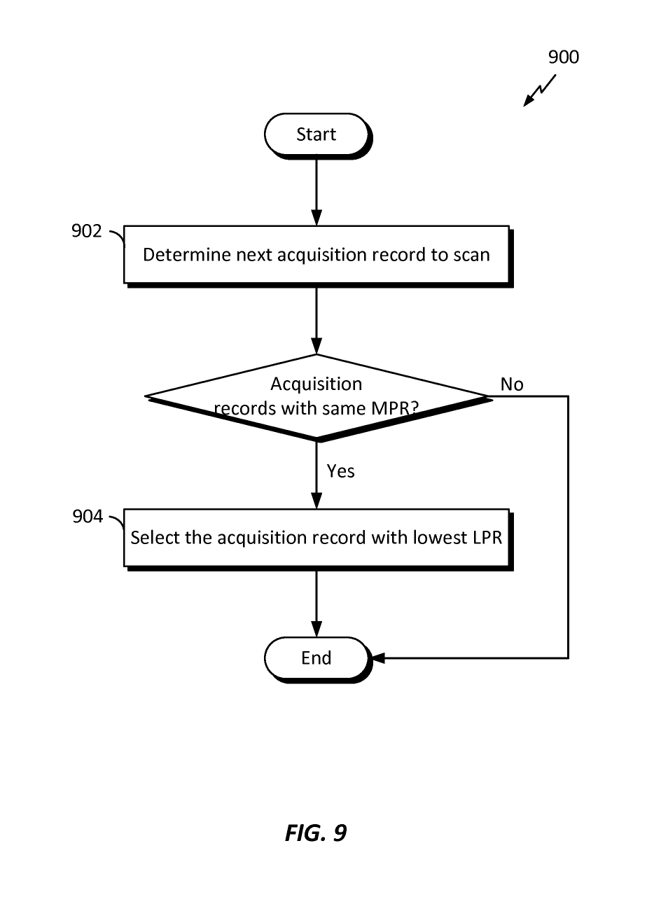

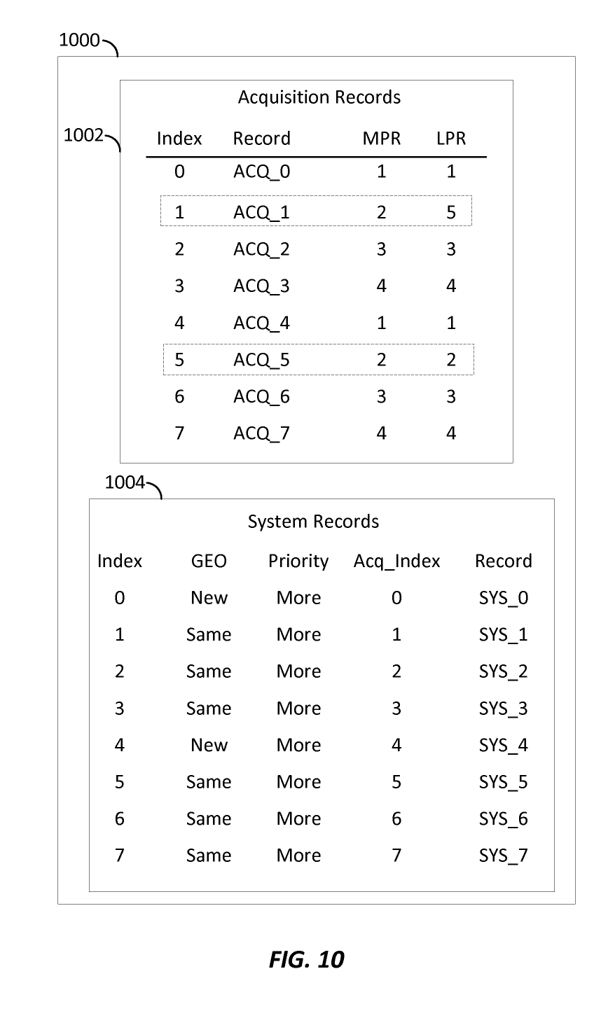

FIG. 9 is a flow chart illustrating a method 900 of selecting acquisition records with the same MPR for service scan in accordance with an aspect of the disclosure. The method 900 may be performed by any AT as illustrated in FIGS. 1, 3, and/or 4. For example, the method 900 may be performed by an AT 300 of FIG. 3 on a PRL 1000 as shown in FIG. 10. In this example, the AT will scan the acquisition records 1002 in the order of ACQ_0, ACQ_4, ACQ_5, ACQ_1, ACQ_2, ACQ_6, ACQ_3, and ACQ_7 according to the methods 800 and 900. After scanning the records ACQ_0 and ACQ_4, the AT will select the next acquisition record in block 806 of FIG. 8. In this case, the acquisition records with the next lowest MPR are ACQ_1 and ACQ_5 (i.e., MPR=2) in PRL 1000. In one example, when multiple acquisition records have the same MPR, the AT may select the next acquisition record among acquisition records with the same MPR according to the method 900 in block 806 of FIG. 8.

Referring to FIG. 9, at block 902, the AT determines the next acquisition record to scan. If two or more acquisition records with the same next lowest MPR are available, the AT selects the acquisition record with the lowest LPR in block 904. If two or more acquisition records have the same MPR and LPR, the AT may select one of the acquisition records in random, a predetermined order, or based on their index values in the PRL. For example, the AT may select the acquisition record with the lower index value in the PRL.

Several aspects of a telecommunications system have been presented with reference to a CDMA system. As those skilled in the art will readily appreciate, various aspects described throughout this disclosure may be extended to other telecommunication systems, network architectures and communication standards.

By way of example, various aspects may be extended to UMTS systems such as W-CDMA, TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in

FIGS. 3-5 and 7-9 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1 and 3-4 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of service scan operable at an access terminal, comprising:
parsing a preferred roaming list (PRL) comprising a plurality of acquisition records and a plurality of system records, wherein each of the acquisition records comprises information on a most preferred rank (MPR) and a least preferred rank (LPR) of the associated system records;
for each of the acquisition records, ranking the system records associated with the acquisition record; and
performing a service scan utilizing the acquisition records in an order based on the ranking of the system records associated with each of the acquisition records.

2. The method of claim 1,
wherein the ranking the system records comprises determining the most preferred rank (MPR) and the least preferred rank (LPR) of the system records associated with the acquisition record; and
wherein the performing the service scan comprises selecting the acquisition records in an order based on the MPR and LPR.

3. The method of claim 1, wherein the performing the service scan comprises:
sorting the acquisition records based on a most preferred rank of the associated system records; and
selecting the acquisition records in the sorted order for the service scan.

4. The method of claim 1, wherein the performing the service scan comprises:
selecting the acquisition records in an order based on a most preferred rank of the acquisition records.

5. The method of claim 1, wherein the performing the service scan comprises:
selecting the acquisition records in an ascending order of a most preferred rank of the acquisition records.

6. The method of claim 1, wherein the performing the service scan comprises:
for the acquisition records having a same most preferred rank, selecting the acquisition records in an order based on a least preferred rank of the acquisition records.

7. The method of claim 1, wherein the performing the service scan comprises:
for the acquisition records having a same most preferred rank, selecting the acquisition records in an ascending order of a least preferred rank of the acquisition records.

8. An access terminal, comprising:
means for parsing a preferred roaming list (PRL) comprising a plurality of acquisition records and a plurality of system records, wherein each of the acquisition records comprises information on a most preferred rank (MPR) and a least preferred rank (LPR) of the associated system records;
means for ranking the system records associated with each of the acquisition records; and
means for performing a service scan utilizing the acquisition records in an order based on the ranking of the system records associated with each of the acquisition records.

9. The access terminal of claim 8,
wherein the means for ranking the system records is configured to determine the most preferred rank (MPR) and the least preferred rank (LPR) of the system records associated with the acquisition record; and
wherein the means for performing the service scan is configured to select the acquisition records in an order based on the MPR and LPR.

10. The access terminal of claim 8, wherein the means for performing the service scan is configured to:
sort the acquisition records based on a most preferred rank of the associated system records; and
select the acquisition records in the sorted order for the service scan.

11. The access terminal of claim 8, wherein the means for performing the service scan is configured to:
select the acquisition records in an order based on a most preferred rank of the acquisition records.

12. The access terminal of claim 8, wherein the means for performing the service scan is configured to:
select the acquisition records in an ascending order of a most preferred rank of the acquisition records.

13. The access terminal of claim 8, wherein the means for performing the service scan is configured to:
for the acquisition records having a same most preferred rank, select the acquisition records in an order based on a least preferred rank of the acquisition records.

14. The access terminal of claim 8, wherein the means for performing the service scan is configured to:
for the acquisition records having a same most preferred rank, select the acquisition records in an ascending order of a least preferred rank of the acquisition records.

15. A computer-readable medium comprising code for causing an access terminal to:
parse a preferred roaming list (PRL) comprising a plurality of acquisition records and a plurality of system records, wherein each of the acquisition records comprises information on a most preferred rank (MPR) and a least preferred rank (LPR) of the associated system records;
for each of the acquisition records, rank the system records associated with the acquisition record; and
perform a service scan utilizing the acquisition records in an order based on the ranking of the system records associated with each of the acquisition records.

16. The computer-readable medium of claim 15, further comprising code for causing the access terminal to:
determine the most preferred rank (MPR) and the least preferred rank (LPR) of the system records associated with the acquisition record; and
select the acquisition records in an order based on the MPR and LPR.

17. The computer-readable medium of claim 15, further comprising code for causing the access terminal to:
sort the acquisition records based on a most preferred rank of the associated system records; and
select the acquisition records in the sorted order for the service scan.

18. The computer-readable medium of claim 15, further comprising code for causing the access terminal to:
select the acquisition records in an order based on a most preferred rank of the acquisition records.

19. The computer-readable medium of claim 15, further comprising code for causing the access terminal to:
select the acquisition records in an ascending order of a most preferred rank of the acquisition records.

20. The computer-readable medium of claim 15, further comprising code for causing the access terminal to:
for the acquisition records having a same most preferred rank, select the acquisition records in an order based on a least preferred rank of the acquisition records.

21. The computer-readable medium of claim 15, further comprising code for causing the access terminal to:
for the acquisition records having a same most preferred rank, select the acquisition records in an ascending order of a least preferred rank of the acquisition records.

22. An access terminal, comprising:
at least one processor;
a communication interface coupled to the at least one processor;
a memory coupled to the at least one processor;
a preferred roaming list parsing component configured to parse a preferred roaming list (PRL) comprising a plurality of acquisition records and a plurality of system records, wherein each of the acquisition records comprises information on a most preferred rank (MPR) and a least preferred rank (LPR) of the associated system records;
a system ranking component configured to rank the system records associated with each of the acquisition records; and
a service scan component configured to perform a service scan utilizing the acquisition records in an order based on the ranking of the system records associated with each of the acquisition records.

23. The access terminal of claim 22,
wherein the system ranking component is configured to determine the most preferred rank (MPR) and the least preferred rank (LPR) of the system records associated with the acquisition record; and
wherein the service scan component is configured to select the acquisition records in an order based on the MPR and LPR.

24. The access terminal of claim 22, wherein the service scan component is configured to:
sort the acquisition records based on a most preferred rank of the associated system records; and
select the acquisition records in the sorted order for the service scan.

25. The access terminal of claim 22, wherein the service scan component is configured to:
select the acquisition records in an order based on a most preferred rank of the acquisition records.

26. The access terminal of claim 22, wherein the service scan component is configured to:
select the acquisition records in an ascending order of a most preferred rank of the acquisition records.

27. The access terminal of claim 22, wherein the service scan component is configured to:
for the acquisition records having a same most preferred rank, select the acquisition records in an order based on a least preferred rank of the acquisition records.

28. The access terminal of claim 22, wherein the service scan component is configured to:
for the acquisition records having a same most preferred rank, select the acquisition records in an ascending order of a least preferred rank of the acquisition records.
